(19) United States
(12) Patent Application Publication
(10) Pub. No.: US 2019/0219150 A1
(43) Pub. Date: Jul. 18, 2019

(54) SHIFT DEVICE

(71) Applicant: Kabushiki Kaisha Tokai-Rika-Denki-Seisakusho, Aichi-ken (JP)

(72) Inventors: Jun KANATANI, Aichi-ken (JP); Susumu Mega, Aichi-ken (JP); Go Sasaki, Aichi-ken (JP); Masayuki Aoyama, Aichi-ken (JP); Takahiko Matsuzawa, Aichi-ken (JP)

(21) Appl. No.: 16/248,994

(22) Filed: Jan. 16, 2019

(30) Foreign Application Priority Data
Jan. 18, 2018 (JP) 2018-006400

(51) Int. Cl. F16H 59/02

(52) U.S. Cl. CPC F16H 59/0204; F16H 59/0278

(57) ABSTRACT

At a shift device, at a time when a shift position of a lever is a “D” position, a knob is slid toward a right side with respect to a lever main body, and the shift position of the lever is changed to an “M” position. Here, the knob is slid with respect to the lever main body. Therefore, changes in posture of the knob can be restricted, and operability of the knob can be improved.

### CROSS-REFERENCE TO RELATED APPLICATION

This application claims priority under 35 USC 119 from Japanese Patent Application No. 2018-006400, filed Jan. 18, 2018, the disclosure of which is incorporated by reference herein.

### BACKGROUND

### Field of the Invention

The present disclosure relates to a shift device at which a moving body and a changing body are moved, and a shift position is changed.

### Related Art

In the shift operation device disclosed in Japanese Patent Application Laid-Open (JP-A) No. 2006-7993, a lever portion is tilted and the range is changed, and a gripping portion is tilted with respect to the lever portion and the range is changed.

Here, in this shift operation device, as described above, the gripping portion is tilted with respect to the lever portion.

### SUMMARY

In view of the above-described circumstances, there is provided a shift device in which the operability of a changing body can be improved.

A shift device of a first aspect includes a shift body that includes: a moving body, a shift position of the shift body being changed due to the moving body being moved; and a changing body that is capable of moving together with the moving body, the shift position of the shift body being changed due to the changing body being slid with respect to the moving body.

A shift device of a second aspect, in the shift device of the first aspect, further includes an operation portion that is provided at the moving body, wherein movement of the moving body is permitted due to the operation portion being operated.

In a shift device of a third aspect, in the shift device of the second aspect, the operation portion is operated, and movement of the moving body is permitted, by electrical operation.

In a shift device of a fourth aspect, in the shift device of any one of the first through third aspects, sliding of the changing body with respect to the moving body is restricted at a shift position that is different from a predetermined shift position of the shift body.

In a shift device of a fifth aspect, in the shift device of any one of the first through fourth aspects, the changing body is held with respect to the moving body at the predetermined shift position of the shift body.

In the shift device of the first aspect, the changing body can move together with the moving body. The moving body is moved, and the shift position of the shift body is changed. The changing body is slid with respect to the moving body, and the shift position of the shift body is changed.

Here, the changing body is slid with respect to the moving body. Therefore, changes in the posture of the changing body can be suppressed, and the operability of the changing body can be improved.

In the shift device of the second aspect, the operation portion is operated, and movement of the moving body is permitted.

Here, the operation portion is provided at the moving body. Therefore, differently than a case in which the operation portion is provided at the changing body, the operation portion can be provided easily.

In the shift device of the third aspect, the operation portion is operated, and movement of the moving body is permitted by electric operation. Therefore, the structure that connects the operation portion and the movement permitting mechanism of the moving body can be made to be simple.

In the shift device of the fourth aspect, sliding of the changing body with respect to the moving body is restricted at shift positions that are different than a predetermined shift position. Therefore, the changing body being slid needlessly with respect to the moving body can be restricted at shift positions that are different than the predetermined shift position.

In the shift device of the fifth aspect, at the predetermined shift position, the changing body is held with respect to the moving body. Therefore, the changing body being slid from the predetermined shift position needlessly with respect to the moving body can be suppressed.

### BRIEF DESCRIPTION OF THE DRAWINGS

An exemplary embodiment will be described in detail with reference to the following figures, wherein:

FIG. 1 is a perspective view that is seen from an obliquely right and rear side, and shows a shift device relating to an exemplary embodiment;

FIG. 2 is a perspective view that is seen from an obliquely right and rear side, and shows main portions of the shift device relating to the exemplary embodiment;

FIG. 3 is a plan view that is seen from above, and shows main portions of the shift device relating to the exemplary embodiment; and

FIGS. 4A and 4B are cross-sectional views in which the shift device relating to the exemplary embodiment is seen from the rear, and FIG. 4A shows a time at which a lever is disposed at a “D” position, and FIG. 4B shows a time at which the lever is disposed at an “M” position.

### DETAILED DESCRIPTION

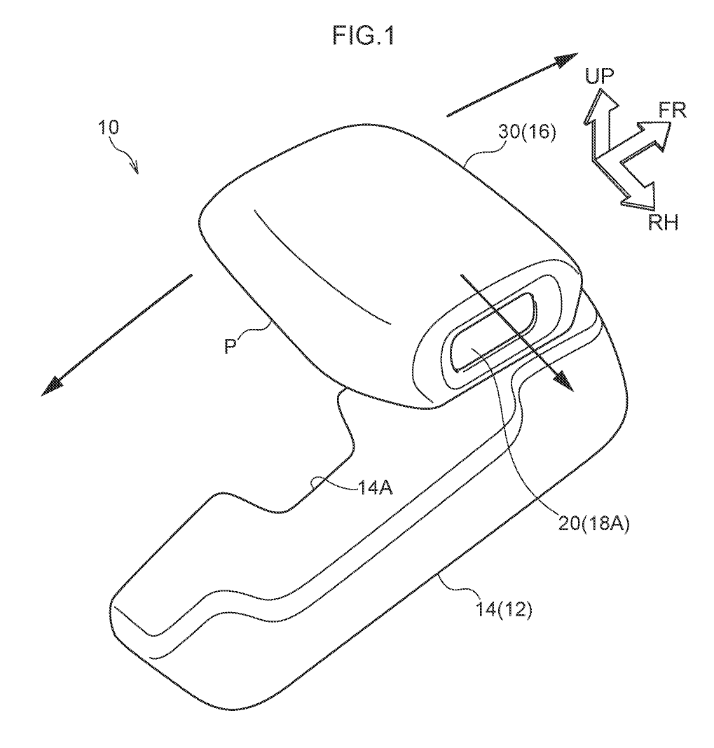

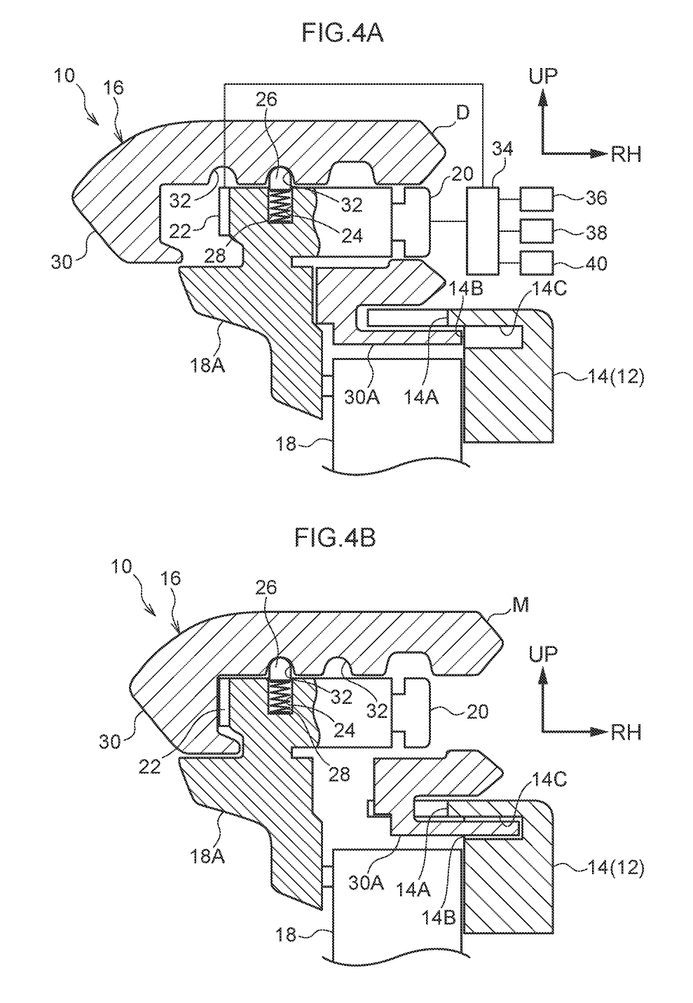

A shift device 10 relating to an exemplary embodiment is shown in FIG. 1 in a perspective view that is seen from an obliquely right and rear side. The shift device 10 is shown in FIG. 4A in a cross-sectional view seen from the rear. Note that, in the drawings, the frontward direction of the shift device 10 is indicated by arrow FR, the rightward direction of the shift device 10 is indicated by arrow RH, and the upward direction of the shift device 10 is indicated by arrow UP.

The shift device 10 relating to the exemplary embodiment is a floor-type shift device, and is set at the vehicle transverse direction central portion of the floor portion (the vehicle body) of the vehicle cabin of a vehicle (an automobile). The frontward, rightward and upward directions of the shift device 10 respectively are directed in the frontward, rightward (the driver's seat side) and upward directions of the vehicle.

As shown in FIG. 1 and FIG. 4A, a plate 12 that is substantially rectangular parallelepiped and serves as a supporting body is provided at the shift device 10. The plate 12 is set (fixed) to the floor portion of the vehicle cabin.

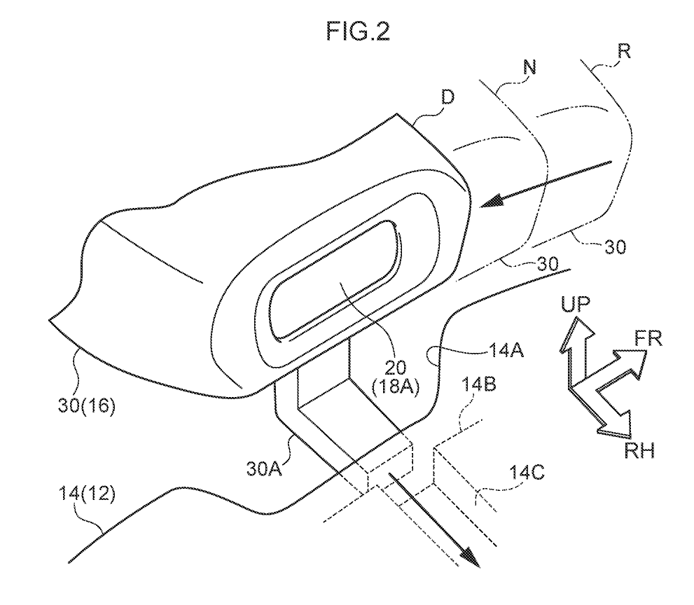

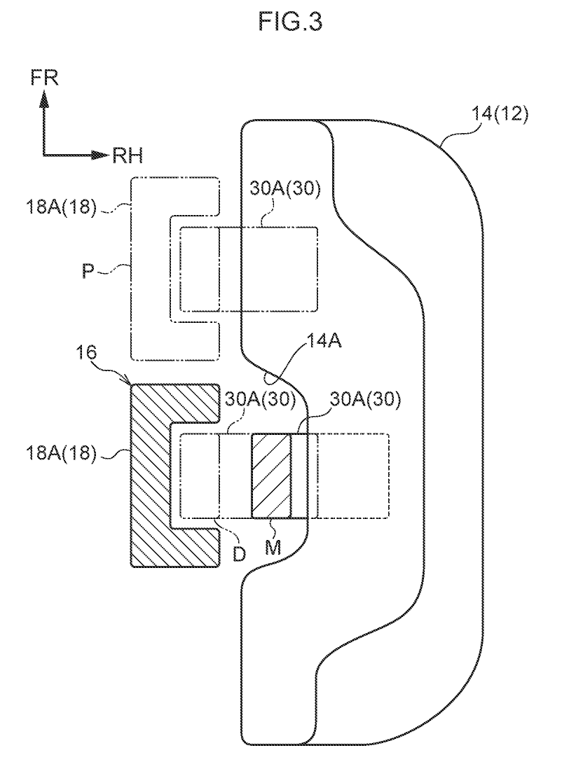

The right side portion of the upper portion of the plate 12 is structured by a gate 14 that serves as a restricting body. The upper wall of the gate 14 structures the upper wall of the plate 12, and the right wall of the gate 14 structures the right wall of the plate 12. An insertion hole 14A (see FIG. 2 and FIG. 3) that is trapezoidal and serves as an insertion portion is formed so as to pass-through the rear portion of the upper wall of the gate 14. The insertion hole 14A opens toward the left side. The left surface of the right wall of the gate 14 is a restricting surface 14B (see FIG. 2) that is planar and serves as a restricting portion. The restricting surface 14B is disposed at the right side of the insertion hole 14A, and extends in the front and rear direction. A release hole 14C (see FIG. 2) that is shaped as a rectangular pillar and serves as a release portion is formed at the rear portion of the right wall of the gate 14. The release hole 14C is disposed at the same front and rear direction position as the insertion hole 14A, and opens toward the left side from the restricting surface 14B.

A lever 16, which is substantially shaped as an elongated pillar and serves as a shift body, is accommodated within the plate 12. The lever 16 extends in the upper and lower direction (vertical direction vertical to the upper wall of the plate 12). A lever main body 18 that serves as a moving body is provided at the lever 16. A supporting shaft (not illustrated in the drawings) is provided at the lower end portion of the lever main body 18 (the lower end portion of the lever 16). The supporting shaft is supported at the plate 12, and the axial direction of the supporting shaft is parallel to the left and right direction. The lever 16 can rotate (move) in the front and rear direction (the shifting direction) around the supporting shaft. The lever 16 passes-through the upper wall of the plate 12 so as to be able to rotate in the front and rear direction, and the upper portion of the lever 16 projects-out at the upper side of the plate 12. The lever 16 is rotated in the front and rear direction, and the shift position thereof can be changed thereby. The shift position of the lever 16 is changed (see FIG. 2) to, from the front side toward the rear side, to a “P” position (parking position), an “R” position (reverse position), an “N” position (neutral position), and a “D” position (drive position, a predetermined shift position).

A mounting portion 18A (see FIG. 3) is provided at the upper end portion of the lever main body 18. The mounting portion 18A is formed integrally with portion of the lever main body 18 other than the mounting portion 18A, and the lower portion of the mounting portion 18A passes-through the upper wall of the plate 12 at the left side of the gate 14. The lower portion of the mounting portion 18A is substantially shaped as a U-shaped pillar in cross-section. The axial direction of the lower portion of the mounting portion 18A is disposed parallel to the upper and lower direction (the axial direction of the lever 16), and the interior opens to the right side. The upper portion of the mounting portion 18A is substantially shaped as a rectangular pillar, and the axial direction of the upper portion of the mounting portion 18A is disposed parallel to the left and right direction. A button 20 that serves as an operation portion is provided at the right end portion of the upper portion of the mounting portion 18A. A switch 22 that serves as a slide detecting portion is provided at the left end portion of the upper portion of the mounting portion 18A.

An urging hole 24 that is solid cylindrical is formed in the upper portion of the mounting portion 18A. The axial direction of the urging hole 24 is disposed parallel to the upper and lower direction, and the urging hole 24 opens toward the upper side. A pin 26, which is substantially solid cylindrical and serves as a holding member, is fit-together with the urging hole 24. The upper surface of the pin 26 protrudes-out in a spherical shape. A spring 28 (a compression coil spring) that serves as an urging member spans between the lower surface of the pin 26 and the lower surface (the bottom surface) of the urging hole 24, and the spring 28 urges the pin 26 toward the upper side.

A knob 30, which is substantially shaped as a rectangular tube having a bottom and that serves as a changing body and an operating body, is mounted to the periphery of the mounting portion 18A. The axial direction of the knob 30 is disposed parallel to the left and right direction, and the interior of the knob 30 opens to the right side. The upper portion of the mounting portion 18A is fit-together with the knob 30 interior. The upper and lower direction intermediate portion of the mounting portion 18A passes-through the lower wall of the knob 30. The knob 30 can slide in the left and right direction (the selecting direction) with respect to the mounting portion 18A (movement of the knob 30 in the upper and lower direction and the front and rear direction with respect to the mounting portion 18A is restricted). The button 20 of the mounting portion 18A is exposed from the right side opening of the knob 30 interior. The left surface (bottom surface) of the knob 30 interior is separated from the switch 22 of the mounting portion 18A toward the left side.

The knob 30 is disposed at the upper side of the plate 12. The knob 30 is gripped by an occupant of the vehicle (the driver in particular), and can be rotatingly operated in the front and rear direction, and can be slidingly operated in the left and right direction. Further, the button 20 can be operated (push-operated) by a vehicle occupant.

A pair of holding holes 32 that are hemispherical and serve as held portion are formed at the upper surface of the knob 30 interior. The pair of holding holes 32 are lined-up at a predetermined interval in the left and right direction. The pin 26 is inserted in (the upper surface of the pin 26 fits-together with) the holding hole 32 that is at the right side due to the urging force of the spring 28 at the mounting portion 18A, so the knob 30 is thereby held in a state of having been slid toward the left side (see FIG. 4A). At the time when the knob 30 is slid toward the right side with respect to the mounting portion 18A, the pin 26 comes away from the holding hole 32 that is at the right side against the urging force of the spring 28, and thereafter, is inserted in the holding hole 32 that is at the left side by the urging force of the spring 28, and the knob 30 is held in a state of having been slid toward the right side (see FIG. 4B).

A restricting projection 30A (see FIG. 2 and FIG. 3), which is shaped as an L-shaped plate in cross-section and serves as a restricted portion, is provided integrally with the lower wall of the knob 30. The restricting projection 30A is disposed at the lower side of the knob 30. The base (proximal) end side portion of the restricting projection 30A projects-out toward the lower side from the lower wall of the knob 30, and is disposed within the lower portion of the mounting portion 18A. The distal end side portion of the restricting projection 30A extends-out toward the right side, and extends-out toward the right side with respect to the lower portion of the mounting portion 18A. The proximal end side portion of the restricting projection 30A passes-through the upper wall of the plate 12 at the left side of the gate 14. The distal end side portion of the restricting projection 30A is disposed at the lower side of the upper wall of the gate 14.

At the times when the shift position of the lever 16 is the “P” position, the “R” position, the “N” position, the proximal end side portion of the restricting projection 30A faces the left surface of the upper wall of the gate 14, and the distal end surface (the right surface) of the restricting projection 30A faces the restricting surface 14B of the gate 14. Therefore, the distal end surface of the restricting projection 30A abuts the restricting surface 14B of the gate 14, and sliding of the knob 30 toward the right side is restricted. At the time when the shift position of the lever 16 is the “D” position, the proximal end side portion of the restricting projection 30A faces the insertion hole 14A of the upper wall of the gate 14, and the distal end surface of the restricting projection 30A faces the release hole 14C of the gate 14. Therefore, the proximal end side portion of the restricting projection 30A is inserted in the insertion hole 14A of the gate 14, and the distal end side portion of the restricting projection 30A is inserted in the release hole 14C of the gate 14, and sliding of the knob 30 toward the right side is permitted (the restriction is cancelled).

Further, due to the knob 30 being slid toward the right side, the shift position of the lever 16 is changed to the “M” position (manual position) (see FIG. 4B). Moreover, at the time when the shift position of the lever 16 is changed to the “M” position, the switch 22 of the mounting portion 18A is pushed by the left surface of the knob 30 interior, and is changed from OFF to ON.

The button 20 and the switch 22 of the mounting portion 18A are electrically connected to a control device 34 of the vehicle, respectively. A detecting mechanism 36 is electrically connected to the control device 34, and the detecting mechanism 36 detects the rotational position of the lever 16 (the lever main body 18) in the front and rear direction. Due thereto, on the basis of inputs from the detecting mechanism 36 and the switch 22, the control device 34 detects that the shift position of the lever 16 is the “P” position, the “R” position, the “N” position, the “D” position or the “M” position. An automatic transmission 38 that serves as the transmission of the vehicle is electrically connected to the control device 34. At the time when the shift position of the lever 16 is changed, due to control of the control device 34, the shift range of the automatic transmission 38 is changed to the shift range that corresponds to the shift position of the lever 16.

A restricting mechanism 40 (locking mechanism) that serves as a movement permitting mechanism is electrically connected to the control device 34. The restricting mechanism 40 restricts rotation of the lever 16 (the lever main body 18) in the front and rear direction, and restricts (locks) a predetermined changing of shift position of the lever 16 (predetermined changing between the “P” position, the “R” position, the “N” position and the “D” position, e.g., changing from the “P” position to the “R” position). At the time when the button 20 is operated, due to the restricting mechanism 40 being electrically operated by control of the control device 34, the restricting mechanism 40 permits rotation of the lever 16 (the lever main body 18) in the front and rear direction, and permits (unlocks) the predetermined changing of the shift position of the lever 16.

Operation of the present exemplary embodiment is described next.

In the shift device 10 of the above-described structure, the lever 16 (the lever main body 18 and the knob 30) is rotated in the front and rear direction, and the shift position of the lever 16 is changed to the “P” position, the “R” position, the “N” position or the “D” position. Moreover, at the time when the shift position of the lever 16 is the “D” position, the knob 30 is slid toward the right side with respect to the lever main body 18, and the shift position of the lever 16 is changed to the “M” position.

Further, the restricting mechanism 40 restricts the predetermined changing of shift position that is due to rotation of the lever 16 in the front and rear direction. At the time when the button 20 is operated, the restricting mechanism 40 permits the predetermined changing of the shift position due to rotation of the lever 16 in the front and rear direction.

Here, as described above, the knob 30 is slid with respect to the lever main body 18. Therefore, differently than in a case in which the knob 30 is tilted (tilt-moved), changes in the posture of the knob 30 can be restricted, and the operability of the knob 30 can be improved. Moreover, the need to support the lever main body 18 so as to be rotatable not only in the front and rear direction but also in the left and right direction can be eliminated. The shift device 10 can share a supporting structure for the lever main body 18 with shift devices in which movement of the knob 30 in the left and right direction is unnecessary, and the supporting structure of the lever main body 18 can be made to be simple, and the shift device 10 can be made compact and the cost thereof lowered.

Further, the button 20 is provided at the lever main body 18 (the mounting portion 18A). Therefore, differently than in a case in which the button 20 is provided at the knob 30, the button 20 can easily be connected to the lever main body 18 side, and the button 20 can be provided easily.

Moreover, the button 20 is electrically connected to the restricting mechanism 40. Due to the button 20 being operated and operation thereof being released, the restricting mechanism 40 is electrically operated, and rotation of the lever 16 in the front and rear direction is permitted and restricted, respectively. Therefore, the structure that connects the button 20 and the restricting mechanism 40 can be made to be simple.

Further, at the time when the shift position of the lever 16 is the “D” position (the predetermined shift position), the proximal end side portion of the restricting projection 30A of the knob 30 is inserted in the insertion hole 14A of the gate 14, and further the distal end side portion of the restricting projection 30A is inserted in the release hole 14C of the gate 14, so sliding of the knob 30 toward the right side is permitted. On the other hand, at the times when the shift position of the lever 16 is the “P” position, the “R” position, the “N” position, the distal end surface of the restricting projection 30A of the knob 30 abuts the restricting surface 14B of the gate 14, so sliding of the knob 30 toward the right side is restricted. Therefore, at the times when the shift position of the lever 16 is the “P” position, the “R” position, the “N” position (shift position different than the “D” position), the knob 30 being slid needlessly toward the right side can be restricted.

Moreover, at the times when the shift position of the lever 16 is the “D” position, the “M” position, respectively, the pin 26 of the lever main body 18 (the mounting portion 18A) is inserted in the respective holding hole 32 of the knob 30 due to the urging force of the spring 28, respectively, and the knob 30 is held with respect to the lever main body 18. Therefore, the knob 30 being needlessly slid from the “D” position, the “M” position with respect to the lever main body 18 can be restricted.

Note that, in the present exemplary embodiment, the switch 22 is provided at the mounting portion 18A of the lever main body 18, and is pushed by the inner surface of the knob 30. However, the switch 22 may be provided at the release hole 14C of the gate 14, and may be pushed by the restricting projection 30A of the knob 30.

Moreover, in the present embodiment, the lever main body 18 is made to be rotatable. However, the lever main body 18 may be made to be slidable (movable).

Further, in the present exemplary embodiment, the shift device 10 is set on the floor portion of the vehicle cabin. However, the shift device 10 may be set at the console of the vehicle cabin, the instrument panel, or the steering column.

What is claimed is:

1. A shift device comprising:
a shift body that includes:
a moving body, a shift position of the shift body being changed due to the moving body being moved; and
a changing body that is capable of moving together with the moving body, the shift position of the shift body being changed due to the changing body being slid with respect to the moving body.

2. The shift device of claim 1, further comprising an operation portion that is provided at the moving body, wherein movement of the moving body is permitted due to the operation portion being operated.

3. The shift device of claim 2, wherein the operation portion is operated, and movement of the moving body is permitted, by electrical operation.

4. The shift device of claim 1, wherein sliding of the changing body with respect to the moving body is restricted at a shift position that is different from a predetermined shift position of the shift body.

5. The shift device of claim 2, wherein sliding of the changing body with respect to the moving body is restricted at a shift position that is different from a predetermined shift position of the shift body.

6. The shift device of claim 3, wherein sliding of the changing body with respect to the moving body is restricted at a shift position that is different from a predetermined shift position of the shift body.

7. The shift device of claim 4, wherein the changing body is held with respect to the moving body at the predetermined shift position of the shift body.

8. The shift device of claim 5, wherein the changing body is held with respect to the moving body at the predetermined shift position of the shift body.

9. The shift device of claim 6, wherein the changing body is held with respect to the moving body at the predetermined shift position of the shift body.
